(19) United States
(12) Patent Application Publication
(10) Pub. No.: US 2009/0182449 A1
(43) Pub. Date: Jul. 16, 2009

(54) Machining Method

(75) Inventors: Siegfried Frei, Herdern (CH); Werner Jahnen, Dinhard (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SULZER MARKETS AND TECHNOLOGY AG, WINTERHUR (CH)

(21) Appl. No.: 12/296,205

(22) PCT Filed: Mar. 27, 2007
(86) PCT No.: PCT/EP07/52932

§ 371 Date: Oct. 6, 2008

(30) Foreign Application Priority Data
Apr. 12, 2006 (EP) 06405165.9

(51) Int. Cl. G06F 19/00; B23Q 1/00

(52) U.S. Cl. 700/159; 409/131

(57) ABSTRACT

The invention relates to a machining method for the machining of a workpiece (1) by means of a machining apparatus, including a control and/or regulating unit and a program-controlled data processing unit as well as a manipulator with a machining tool (2) for the manufacture of a three-dimensional structure (3) by machining the workpiece (1) in the region of a curved guide surface (4). In this connection, the machining method includes the steps of storing the geometry and/or the spatial position of the three-dimensional structure (3) to be manufactured in the workpiece (1) in a memory device of the data processing unit; of fixing a spatial coordinate and/or a surface vector of the guide surface (4) while taking account of the geometry and/or the spatial position of the three-dimensional structure (3) to be manufactured in the workpiece (1), with the guide surface (4) being matched to the geometry and to the spatial position of the three-dimensional structure (3) in the workpiece (1) such that the machining tool (2) is not brought into contact with a marginal surface (5) bounding the three-dimensional structure on the machining of the workpiece (1) and the guide surface (4) is not arranged as a parallel surface and/or as an offset surface with respect to any marginal surface (5) and/or any end surface; of guiding the machining tool (2) along the guide surface (4) while machining a machining region (6) of the workpiece (1) pre-set by the guide surface (4) for the formation of the three-dimensional structure (3) in the workpiece (1), with the machining tool (2) being guided along the guide surface (4) at a constant guide angle (α) with respect to a guide axis (7).

The invention relates to a method for the machining of a workpiece by stock removal by means of a machining apparatus, to a computer program product for a data processing unit for the operation of a machining apparatus in accordance with the machining method in accordance with the invention, to a workpiece manufactured in accordance with a machining method in accordance with the invention and to a machining apparatus having a computer program product for the carrying out of the machining method in accordance with the preamble of the independent claim of the respective category.

It is known to produce rotating running wheels, pump wheels, impellers and fixed guide wheels for pumps, compressors or turbines from solid material by machining by stock removal. These methods can be used particularly well when the geometries to be machined are not too complex so that all the regions to be machined in the solid blank with the machining tool can be reached easily and/or when the materials to be machined can be milled or machined mechanically in a comparatively soft or light manner.

With running wheels and guide wheels of a geometrically simple structure which are not exposed to strains which are all that high in the operating state, the running wheels can also be composed of individual parts or be produced from one piece. This applies in particular to guide wheels with a simple structure which are not exposed to mechanical strains which are to large, because they are not moved themselves and thus no imbalance effects or centrifugal forces occur. However, comparatively slowly operating running wheels can also be composed of individual parts with a comparatively low effort, with suitable fitting connections being able to be provided, for example, at the components which are then permanently connected to one another by means of welding. These welds usually only serve the positional fixing and are not suitable for the transfer of larger forces and strains.

In this connection, the fastening of cover discs or hub sheaths to the vanes of impellers is particularly problematic. This problem should be briefly discussed in the following by way of example with reference to radial and axial compressors, with the basic problem also being able to be relevant with other apparatuses.

The radial compressor, for example, like the centrifugal pump, substantially consists of a rotating running wheel, also called a bucket wheel, which is mounted on an axle and can be either open or also provided with a cover, with the running wheel specifically being able to be arranged in a surrounding, fixed guide wheel or being able to be surrounded by a spiral collection space. In this connection, the guide wheel has the shape of a diffuser in which some of the kinetic energy generated in the rotor is converted into pressure energy. In this embodiment, the guide wheel substantially consists of an upper disc and a lower disc, also called a cover and a base respectively, between which guide vanes can be located.

The axial compressor, including a rotor and a stator, consists in a known manner of a rotor designed as a running wheel and having a drive shaft and guide vanes, with the running wheels being able to be designed with or without an outer ring, that is with or without a cover part. The stator is made as an all-compassing housing in which the fixed guide wheels are accommodated, with a stator not having to be provided in every case, such as with specific fans, for example.

It must be made explicitly clear at this point that within the framework of this application the term “guide vane” is to be understood as the common term for the vanes of a running wheel and for the vanes of a guide wheel.

The running wheels are subject to great strain in the operating state since they are partly exposed to considerable centrifugal forces at enormous rotational speeds of, for example, up to 15,000 r.p.m. with a diameter of the running wheel of e.g. 400 mm. In this connection, peripheral speeds of up to 400 m/s and more can typically easily be reached at the outer diameter.

It is therefore known to produce the running wheels from solid material, depending on the application e.g. from high-tensile stainless steels, super alloys or other suitable metals or metal alloys and to produce the guide vanes by machining by stock removal, e.g. by milling, from this material.

If the running wheels, as in the case of an impeller, additionally have to be provided with a cover part in the form of a cover, it is frequently no longer possible for geometrical reasons alone to mill the running wheel in total in one piece from solid material, but rather either an integral base body, which is seated on the driving axle of the compressor, is produced with guide vanes so that a cover part has subsequently to be placed onto the guide vanes and has to be reliably connected thereto. Or it can also be possible in special cases for a cover part with guide vanes to be worked out of solid material in one piece and for the base body which is coupled to the drive axle to have to be subsequently assembled and connected to form a complete impeller.

The base bodies, cover parts and guide vanes must then be welded to one another using specific welding techniques, which is complex and, e.g. in particular at high strains, results in unsatisfactory results, e.g. with respect to strength, running smoothness, etc., and is ultimately relatively expensive.

Basically, components such as impellers, running wheels, etc. produced from one piece of solid material by milling or machining promise better results in this respect. This has, however, not been possible under certain circumstances up to now.

One important aspect during milling which must always be considered is, as already mentioned, first the geometry to be milled and second the properties of the material to be machined of which the component should consist.

On the one hand, there are components which are designed such that they can generally not be produced from a solid blank by milling or by other machining methods, because it is not possible from a purely geometrical aspect to reach all the positions which have to be produced with the machining tool. Components of this type can also not be manufactured using the method of the present invention.

On the other hand, there are components of complex design which should admittedly basically be able to be manufactured using a machining method while taking account solely of the geometry, but which have not been able to be manufactured up to now, at least not in sufficient quality, under economically reasonable conditions or even generally not with the means of the prior art using the previously known machining methods, although the geometry of the component to be produced would generally allow this, that is does not make it generally impossible.

This is ultimately very frequently due to the fact that the setting angle at which a machining tool should ideally be used e.g. in milling, roughing, planning or another machining method is an inherent property of the respective machining tool.

This means that every machining tool has its own setting angle at which it should be set against a surface to be machined during milling in the operating state in order to achieve ideal working results. Such an angle of engagement can, for example, amount to 90°. This means, when the corresponding machining tool is set against a surface to be machined during milling at an angle of 90°, an ideal working result can be achieved with the tool. If, however, there is a deviation from this angle, the tool will provide worse results; if the deviation from the ideal setting angle is major, this will result in unacceptable results, or a machining using a tool of this type is not even possible any longer; in the worst case, the tool and/or the workpiece to be machined can be damaged or even destroyed.

It is therefore frequently not possible with the known milling methods to deviate substantially from the ideal setting angle of the tool. This means a workpiece is completely machined with a more or less constant setting angle. This has the consequence that specific workpieces, which could admittedly be machined by a machining method while taking account of the geometry alone because generally the machining tool can reach all the positions to be machined from a purely geometrical aspect, cannot be manufactured using the known methods because the setting angle of the workpiece cannot be adapted and specific regions can therefore actually not be reached using the machining tool.

However, even if one were to consider changing the setting angle during the milling, as a rule, such workpieces have nevertheless not been able to be manufactured up to now by machining methods alone because e.g. the setting angle would have to be changed so much with respect to the ideal setting angle of the machining tool that the machining tool no longer provides any acceptable work results. This can, for example, mean that the machining tool is no longer able at all—or only very insufficiently able—to machine the material at all at a setting angle necessarily deviating very much, which can above all be the case with very hard workpieces or workpieces difficult to machine for other reasons, or that the quality of the machined surfaces and regions is unacceptably poor due to the setting angle which is unusable for the machining tool.

Problems of this type frequently occur, however, not only when, for example, undercuts have to be manufactured or special tools have to be used, e.g. conical tools with which then specific regions in the workpiece cannot be reached without changing the setting angle in the milling methods known from the prior art or the mentioned undercuts cannot be realised at all.

It is therefore the object of the invention to provide a machining method with which complex geometries can also be manufactured, in particular also in materials which are very difficult to machine, which e.g. have a high strength or a high hardness and which have not been able to be manufactured up to now using the methods known from the prior art.

The subjects of the invention satisfying these objects in a technical method respect and in an apparatus respect are characterised by the features of the independent claim of the respective category.

The independent claims relate to particularly advantageous embodiments of the invention.

The invention thus relates to a machining method for the machining of a workpiece by means of a machining apparatus, including a control and/or regulating unit and a program-controlled data processing unit as well as a manipulator with a machining tool for the manufacture of a three-dimensional structure by machining the workpiece in the region of a curved guide surface. In this connection, the machining method includes the steps of storing the geometry and/or the spatial position of the three-dimensional structure to be manufactured in the workpiece in a memory device of the data processing unit; of fixing a spatial coordinate and/or a surface vector of the guide surface while taking account of the geometry and/or the spatial position of the three-dimensional structure to be manufactured in the workpiece, with the guide surface being matched to the geometry and to the spatial position of the three-dimensional structure in the workpiece such that the machining tool is not brought into contact with a marginal surface bounding the three-dimensional structure on the machining of the workpiece and the guide surface is not arranged as a parallel surface and/or as an offset surface with respect to any marginal surface and/or any end surface; of guiding the machining tool along the guide surface while machining a machining region of the workpiece pre-set by the guide surface for the formation of the three-dimensional structure in the workpiece, with the machining tool being guided along the guide surface at a constant guide angle with respect to a guide axis.

It is important for the invention that the machining tool is guided along a specific guide surface at a constant guide angle with respect to its guide axis.

This is achieved in that first the geometry and the spatial position of the three-dimensional structure to be manufactured is detected and is stored in a memory of an electronic control device, e.g. of a multiaxis milling machine, in particular a five-axis milling machine, or CNC machine and then all the guide surfaces are calculated while taking account of these data, along which surfaces the machining tool is guided successively in a machining manner for the manufacture of the workpiece. In this process, the guide surfaces are calculated so that, on the one hand, the machining tool is guided at one and the same angle while machining at least with respect to a specific guide surface, preferably with respect to all calculated guide surfaces, namely substantially at the ideal guide angle for the machining tool. It is understood that the machining tool can also be guided at a guide angle slightly deviating from the ideal guide angle given by the manufacturer of the machining tool so that the quality of the workpiece manufactured by machining does not suffer due to the slight deviation from the ideal guide angle and the machining tool can also substantially still work ideally. If e.g. an ideal guide angle, also called a setting angle above, for a machining tool of e.g. 90° is given, a certain deviation, e.g. by +/−5° or +/−1° or lower, or another insignificant angular deviation in the guide angle can easily be tolerable in dependence on the material to be machined or on the machining tool used.

In this connection, the guide surfaces are not only fixed by the method in accordance with the invention such that the guide angle for the guiding of the machining tool is substantially constant, but all guide surfaces are moreover calculated in advance such that the machining tool is not brought into contact with a marginal surface bounding the three-dimensional structure on the machining of the tool and the guide surface is not arranged with respect to any marginal surface and/or any end surface as a parallel surface and/or as an offset surface.

Within the framework of this application, offset surface is to be understood as those surfaces which are admittedly not parallel in the strict sense, such as e.g. two non-curved planes, but do have the same spacing from one another everywhere. An example for this is presented e.g. by two concentric spherical shells with different diameters which are at a fixed spacing to one another over the total surface, but nevertheless have different radii of curvature and are thus not actually parallel in a strict sense, but form offset surfaces with respect to one another.

In a special embodiment of a method in accordance with the invention, the spatial coordinate and/or the surface vector of at least two different guide surfaces is/are generated in a separate part step, in particular in a separate computer part program. This means that it can be advantageous in specific cases, to break down e.g. a computer program, with which a method in accordance with the invention can be mapped electronically, into a plurality of part processes or sub-programs which, for example, combine specific classes of guide surfaces, or a group of guide surfaces, which are associated with specific regions of the workpiece to be machined or are matched in another manner to a specific problem, and first make a separate calculation in the respective part sections while taking account of specific special features and then joining together the results to a total set of all guide surfaces required.

It is understood that in a completely analogous manner, in addition to the coordinates of the guide surface, a tool coordinate and/or a tool vector of the machining tool can be matched to the guide surface, i.e. the invention naturally also relates to methods in which the tool coordinates and tool vectors are calculated directly, with these tool coordinates and tool vectors resulting in work surfaces which are identical to the guide surfaces in the sense of the application.

In an example particularly important for practice, at least two guide surfaces are not parallel to one another. This means that different guide surfaces can e.g. have different constant or non-constant radii of curvature and/or can have e.g. the same radii of curvature or a same extent of the radius of curvature and nevertheless not be parallel and/or not form any offset surfaces to one another.

The guide angle of the machining tool is preferably not changed with respect to the guide surfaces during the total machining process in the manufacture of the three-dimensional structure.

It can naturally be possible in specific cases for the guide angle to be varied in accordance with a predetermined scheme during the manufacture of the three-dimensional structure on a change from one guide surface to a next guide surface, with the guide angle preferably only deviating a little, e.g. only by 0.5° or at most 1°, from the ideal guide angle at all guide surfaces.

Depending on the demand, on the material to be machined, on the specific geometry to be machined or in dependence on other parameters, the change of the machining tool can be carried out discontinuously from one guide surface to a next guide surface and/or, for the changing of one guide surface to a next guide surface, a bore can be provided in the region of the guide surface, in particular in the region of all guide surfaces, for this purpose. A ramp-shaped or ramp-like transition from one guide surface to the next guide surface is also possible.

This means that when the workpiece has been completely machined in the region of a pre-set guide surface, the transition to a next guide surface can e.g. be effected in that e.g. a bore is introduced, drilled or milled into the material at a predetermined site into the tool at a specific predetermined depth in order to machine the material along a next guide surface in a strength or thickness corresponding to the drilled depth.

It is, however, also possible in specific cases for a bore to be introduced through a plurality of guide surfaces or all guide surfaces prior to the actual machining process; this means that a bore is introduced which passes through some of the material or the total thickness of the material to be machined so that every time a complete plane was removed in a predetermined thickness along one of the pre-calculated guide surfaces, the transition to the next guide surface is effected in that the machining tool is placed in the bore at a depth which substantially corresponds to the thickness of a new material layer to be removed so that, starting from the bore, the material can be removed at a specific thickness along a next guide surface.

The change of the machining tool from one guide surface to a next guide surface can, however, also be carried out continuously, and in particular in the manner of a spiral in the form of a helix whose outer enveloping shape e.g. corresponds to the shape of a structure to be machined such as a channel to be milled out. This means, for example, that the machining tool is advanced more or less continuously in an advancing direction of the machining tool, that is substantially perpendicular to a guide surface such that the transition from a guide surface does not take place discontinuously, but gradually, so that the machining tool carries out e.g. a spiral or helical movement in the advancing direction.

The guide angle, which is set ideally to the machining tool, can be set, depending on the machining tool, e.g. to a value between 70° and 120°, specifically to a value between 85° and 95°, in particular to a value between 88° and 92°, preferably to a value of approximately 90°.

In this connection it is in particular also possible using the method in accordance with the invention to work an undercut into the three-dimensional structure, in that the guide surfaces on or along which the machining tool is guided at a constant guide angle are suitably selected, that is calculated, with specifically even a conical machining tool being able to be used with which undercuts can even be realised while maintaining a constant guide angle on the guide surface.

An impeller or a guide vane, in particular an impeller or a guide vane of a pump, of a compressor or of a turbine can in particular, but naturally not only, be manufactured using the method in accordance with the invention and/or a component and/or a machine housing of a machine part, in particular of a motor and/or a hydraulic and/or a pneumatic component and/or another component can be manufactured and/or the three-dimensional structure can be an open channel and/or a closed channel, in particular an open and/or closed channel of an impeller and/or another three-dimensional structure of a workpiece.

The invention further relates to a computer program product for the generation of a guide surface for the carrying out of one of the methods described in more detail above.

The invention moreover relates to a computer program product for a data processing unit with which a control device for the control and/or regulation of a machining apparatus, in particular of a multiaxial tool machine, specifically a multiaxial CNC machine, can be operated in a program-controlled manner in accordance with a machining method such as described in detail above.

The invention furthermore relates to a workpiece, in particular to an impeller or to a guide vane for a pump, a compressor or a turbine, or a component and/or a machine housing of a machine part, in particular of a motor, and/or a hydraulic and/or a pneumatic component and/or another component and/or a three-dimensional structure, in particular an open channel and/or a closed channel, in particular an open and/or a closed channel of an impeller, and/or another three-dimensional structure of a workpiece manufactured in accordance with a method described above.

In addition, the invention relates to a machining apparatus, in particular to a multiaxial machine tool, specifically to a multiaxial CNC machine, including a control unit and/or a regulation unit and a program-controlled data processing unit as well as a manipulator having a machining tool for the manufacture of a three-dimensional structure by machining a workpiece by stock removal, with a computer program product in accordance with the present invention being implemented on the program-controlled data processing unit so that a machining method in accordance with the invention can be carried out with the machining apparatus for the manufacture of a workpiece in accordance with the invention in the operating state.

The invention will be explained in more detail in the following with reference to the drawing. There are shown in a schematic representation:

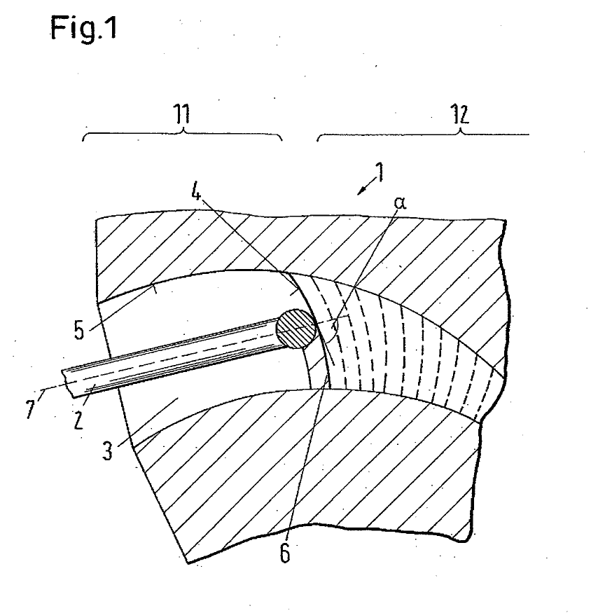

FIG. 1 an impeller with a machining tool and guide surfaces in section.

A workpiece 1, an impeller 1 in the present case, e.g. an impeller of a radial compressor, is shown in section in FIG. 1 in a schematic representation. FIG. 1 shows a machining tool 2 which is guided by a manipulator (not shown in FIG. 1) of a machining apparatus (likewise not shown) for the generation of a three-dimensional structure 3, here of a closed channel 3, in a machining manner along a guide surface 4 for the machining of the machining surface 6.

In a front region 11, a part of the channel 3 to be cut out overall has been completed, whereas the channel 3 is not yet completed in a region 12 adjacent thereto. Prior to the start of the machining procedure for the manufacture of the channel 3 in accordance with the method of the invention, all the guide surfaces 4 were calculated which are shown schematically as curved broken lines in the region 12. In accordance with the invention, the machining tool 2 is guided at a constant angle α with respect to the guide axis 7. The guide surfaces 4 are fixed in this process such that the tool can mill out the whole passage 3 without the guide tool coming into contact with one of the marginal surfaces 5 of the channel 3 which bound the channel 3. The channel 3 of FIG. 1 has a length, for example, of approximately 70 mm up to 160 mm, specifically e.g. 125 mm, e.g. a width and/or height and/or a diameter of e.g. up to 100 mm, specifically up to 50 mm, in particular, for example, also approximately 14.5 mm. It is understood that the dimensions of the three-dimensional structure 3, which is a channel 3 in the example of FIG. 1, can also substantially differ from the previously named special dimensions of the channel of FIG. 1. The material from which the workpiece is made in accordance with a machining method in accordance with the invention is preferably a metal or a metal alloy and is specifically e.g. aluminium, titanium, steel, nickel, a nickel-based or cobalt-based alloy, magnesium, forged material or cast material, a non-iron metal or is another material, for example a plastic or a composite material or another machinable material.

It is thus possible for the first time by the method in accordance with the invention to completely machine a workpiece at a more or less constant setting angle, even if it has a very complex geometrical structure and the material is difficult to machine because, e.g. it has a great hardness and/or a high strength and/or other properties which make the machining more difficult, or makes a machining impossible with specific geometries by the methods known from the prior art.

All the workpieces which can generally be machined by a machining method while taking account of the geometry alone because the machining tool can reach all sites to be machined from a purely geometrical aspect can also actually be manufactured for the first time using the method in accordance with the invention, and indeed also if it is a case of materials which are very difficult to machine and can only be machined when the machining tool is used essentially at its ideal guide angle or setting angle during machining.

This is due to the fact that the setting angle of the machining tool does not have to be adapted at least with respect to a guide surface in order to reach specific regions with the machining tool.

Very complex geometries, also of very hard workpieces or workpieces which are difficult to machine for other reasons, can thus also be manufactured for the first time in a machining manner, and indeed without a loss of quality of the machined surfaces and regions having to be accepted due to a setting angle which cannot be used for the machining tool.

It is thus also possible for the first time, for example, to manufacture undercuts and/or to use special tools, e.g. conical tools, with which specific regions in the workpiece cannot be reached without a change in the setting angle in the milling methods known from the prior art.

1. A method for the machining of a workpiece (1) by stock removal by means of a machining apparatus, including a control unit and/or regulating unit and a program-controlled data processing unit as well as a manipulator with a machining tool (2) for the manufacture of a three-dimensional structure (3) by machining the workpiece (1) in the region of a curved guide surface (4), said machining method including the following steps:
storing in a memory device of the data processing unit the geometry and/or the spatial position of the three-dimensional structure (3) to be manufactured in the workpiece (1);
fixing a spatial coordinate and/or a surface vector of the guide surface (4) while taking account of the geometry and/or the spatial position of the three-dimensional structure (3) to be manufactured in the workpiece (1), with the guide surface (4) being matched to the geometry and to the spatial position of the three-dimensional structure (3) in the workpiece (1) such that the machining tool (2) is not brought into contact with a marginal surface (5) bounding the three-dimensional structure on the machining of the workpiece (1) and the guide surface (4) is not arranged as a parallel surface and/or as a offset surface with respect to any marginal surface (5) and/or any end surface; and
guiding the machining tool (2) along the guide surface (4) while machining a machining region (6) of the workpiece (1) pre-set by the guide surface (4) for the formation of the three-dimensional structure (3) in the workpiece (1),
characterised in that the machining tool (2) is guided along the guide surface (4) at a constant guide angle (a) with respect to a guide axis (7).

2. A machining method in accordance with claim 1, wherein the spatial coordinate and/or the surface vector of at least two different guide surfaces (4) are generated in a separate part step, in particular in a separate computer sub-program.

3. A machining method in accordance with claim 1, wherein a tool coordinate and/or a tool vector of the machining tool (2) is matched to the guide surface (4).

4. A machining method in accordance with claim 1, wherein at least two guide surfaces (4) are not parallel.

5. A machining method in accordance with claim 1, wherein the guide angle (α) is not varied during the manufacture of the three-dimensional structure (3).

6. A machining method in accordance with claim 1, wherein the guide angle (a) is varied in accordance with a pre-set scheme during the manufacture of the three-dimensional structure (3) on a change from one guide surface (4) to a next guide surface (4).

7. A machining method in accordance with claim 1, wherein the change of the machining tool (2) from one guide surface (4) to a next guide surface (4) is carried out discontinuously and/or a bore is provided in the region of the guide surface (4), in particular in the region of all guide surfaces (4) and/or a ramp-shaped and/or a ramp-like transition is carried out from one guide surface to the next guide surface for the changing from one guide surface (4) to a next guide surface (4).

8. A machining method in accordance with claim 1, wherein the change of the machining tool (2) from one guide surface (4) to a next guide surface (4) is carried out continuously, in particular in the manner of a spiral in the form of a helix.

9. A machining method in accordance with claim 1, wherein the guide surface (4) has a constant and/or a non-constant radius of curvature.

10. A machining method in accordance with claim 1, wherein the guide angle (α) is set to a value between 70° and 120°, specifically to a value between 85° and 95°, in particular to a value between 88 and 92°, preferably to a value of approximately 90°.

11. A machining method in accordance with claim 1, wherein an undercut is worked into the three-dimensional structure (3).

12. A machining method in accordance with claim 1, wherein the machining tool (2) is a conical machining tool (2).

13. A machining method in accordance with claim 1, wherein the workpiece (1) is an impeller (1) or a guide vane (1), in particular an impeller (1) or a guide vane (1) of a pump, of a compressor or of a turbine, and/or a component (1) and/or is a machine housing (1) of a machine part, in particular of a motor, and/or is a hydraulic and/or a pneumatic component (1) and/or is another component (1) and/or the three-dimensional structure (3) is an open channel (3) and/or a closed channel (3), in particular an open and/or closed channel (3) of an impeller (1), and/or is another three-dimensional structure (3) of a workpiece (1).

14. A computer program product for generating a guide surface by stock removal by means of a machining apparatus including a control unit and/or regulating unit and a program-controlled data processing unit as well as a manipulator with a machining tool (2) for the manufacture of a three-dimensional structure (3) by machining the workpiece (1) in the region of a curved guide surface (4) comprising
storing in a memory device of the data processing unit the geometry and/or the spatial position of the three-dimensional structure (3) to be manufactured in the workpiece (1),
fixing a spatial coordinate and/or a surface vector of the guide surface (4) while taking account of the geometry and/or the spatial position of the three-dimensional structure (3) to be manufactured in the workpiece (1) the guide surface (4) being matched to the geometry and to the spatial position of the three-dimensional structure (3) in the workpiece (1) so that the machining tool (2) is not brought into contact with a marginal surface (5) bounding the three-dimensional structure on the machining of the workpiece (1) and the guide surface (4) is not arranged as a parallel surface and/or as an offset surface with respect to any marginal surface (5) and/or any end surface,
guiding the machining tool (2) along the guide surface (4) while machining a machining region (6) of the workpiece (1) pre-set by the guide surface (4) for the formation of the three-dimensional structure (3) in the workpiece (1), and
wherein the machining tool (2) is guided along the guide surface (4) at a constant guide angle (α) with respect to a guide axis (7).

15. (canceled)

16. A workpiece, in particular an impeller (1) or a guide vane (1) for a pump, a compressor or a turbine, or a component (1) and/or a machine housing (1) of a machine part, in particular of a motor and/or a hydraulic and/or a pneumatic component (1), and/or another component (1) and/or a three-dimensional structure (3), in particular an open channel (3) and/or a closed channel (3), in particular an open and/or a closed channel (3) of an impeller (1), and/or another three-dimensional structure (3) of a workpiece (1) manufactured in accordance with a method in accordance with claim 1.

17. A machining apparatus, in particular a multiaxial machine tool, specifically a multiaxial CNC machine for generating a guide surface, including a control unit and/or a regulation unit and a program-controlled data processing unit as well as a manipulator having a machining tool (2) for the manufacture of a three-dimensional structure (3) of a workpiece by machining the workpiece (1), and a computer program product implemented on the program-controlled data processing unit which
stores in a memory device of the data processing unit a geometry and/or a spatial position of the three-dimensional structure (3) to be manufactured in the workpiece (1),
fixes a spatial coordinate and/or a surface vector of the guide surface (4) while taking account of the geometry and/or the spatial position of the three-dimensional structure (3) to be manufactured in the workpiece (1), with the guide surface (4) being matched to the geometry and to the spatial position of the three-dimensional structure (3) in the workpiece (1) so that the machining tool (2) is not brought into contact with a marginal surface (5) bounding the three-dimensional structure on the machining of the workpiece (1) and the guide surface (4) is not arranged as a parallel surface and/or as an offset surface with respect to any marginal surface (5) and/or any end surface and
guides the machining tool (2) along the guide surface (4) while machining a machining region (6) of the workpiece (1) pre-set by the guide surface (4) for the formation of the three-dimensional structure (3) in the workpiece (1), along the guide surface (4) at a constant guide angle (a) with respect to a guide axis (7).
